(19) United States
(12) Patent Application Publication
(10) Pub. No.: US 2015/0073580 A1
(43) Pub. Date: Mar. 12, 2015

(54) METHOD AND SYSTEM FOR DYNAMIC AND ADAPTIVE COLLECTION AND USE OF DATA AND METADATA TO IMPROVE EFFICIENCY AND REDUCE LEAKAGE AND THEFT

(71) Applicant: Paul Ortiz, San Francisco, CA (US)

(72) Inventor: Paul Ortiz, San Francisco, CA (US)

(21) Appl. No.: 14/480,602

(22) Filed: Sep. 8, 2014

Related U.S. Application Data
(60) Provisional application No. 61/875,102, filed on Sep. 8, 2013.

(51) Int. Cl. G05B 19/418

(52) U.S. Cl. CPC G05B 19/4183; G05B 2219/31034
USPC 700/115

(57) ABSTRACT

Disclosed is a method of capturing unique device identifiers (“UDI”) associated with products to track movement, time, location via and into a computerized network and then combining the data with additional data outside of the product UDI related data and meta-data such as shipping, distribution, workers, date, and time. In one implementation, Such tracking may be performed in real-time to determine if a leakage or loss alarm or warning threshold has been met.

### PRIORITY CLAIMS

This application is a non-provisional of and claims priority under 35 U.S.C. §119(e) to prior provisional patent application Ser. No. 61/875,102 entitled, “Method and System for Dynamic and Adaptive Collection and Use of Data and Metadata to Improve Efficiency and Reduce Leakage and Theft,” filed Sep. 8, 2013. The entire contents of the aforementioned application are expressly incorporated herein by reference.

### BACKGROUND

1. Field

This disclosure relates generally to the manufacture and distribution of products, and the remediation of leakage and loss associated therewith.

2. General Background

During various stages of manufacturing assembly product flow from station to station during the work in progress (WIP) phase; which is from start end to finish end, is one of the major causes of product leakage. Product leakage is a loss to the manufacture and it can result in grey goods entering the market.

### DISCLOSURE

Lack of real-time monitoring of products during various stages of manufacturing assembly is one of the major causes of product leakage from a manufacturing plant. Embodiments of the methods and systems disclosed herein evaluate criteria associated with at least one of a manufacturing process, site, workforce, environment and pace to evaluate the process. In some instances evaluation involves identifying leakage. In some instances evaluation involves predicting leakage. In some instances evaluation involves identifying loss. In some instances evaluation involves predicting loss.

Embodiments of the method and system of monitoring and/or evaluation may be fine-tuned, e.g., to set alarms, assign numeric values to a data set, report activity above or below a threshold, and predict trends, and/or the like.

The disclosed includes embodiments of methods and systems for capturing a Unique Device Identifier (UDI) associated with products to track factors such as movement, time, location, and/or the like via and into a computerized network and then combining the data with additional data outside of the product UDI related data and meta data such as, e.g., shipping, distribution, workers, date, and time, and determining in real-time if the work flow or distribution or location of the product is such that it warrants an alarm or warning

Embodiments of the disclosed systems and methods are directed to reducing product leakage, the method comprising, in one embodiment, associating a Unique Device Identifier “UDI” with a product which is scanned or otherwise read by a capture device upon one of entry and exit of the product from each Work In Progress “WIP” station including electronically adding a at least one of a geo-location and timestamp; using a computerized network to transmit the captured UDI and time stamp to a computer network to one or more databases wherein it is stored in memory.

The afore and below mentioned monitoring may be supported by a UDI (Unique Device Identifier) connected to or embedded in one or more of the product or components being assembled or manufactured.

Embodiments of the disclosed systems and methods are directed to monitoring criteria associated with a product , which in some instances may be in real-time, during at least one of the supply chain, work in progress (WIP) phases, and distribution for a product.

Embodiments of the disclosed systems and methods are directed to monitoring criteria associated with a product, which in some instances may be dynamically adjusted, during at least one of the supply chain, work in progress (WIP) phases, and distribution for a product

Embodiments of the disclosed systems and methods are directed to monitoring criteria associated with a product, which in some instances may be adaptively adjusted to variables associated with the product, workforce, environment, time, climate, weather, and date during the work in progress (WIP) phases for the product.

Embodiments of the disclosed systems and methods are directed to securing supply chains via real-time production & reconciliation.

### BRIEF DESCRIPTION OF THE FIGURES

The disclosure may be better understood by referring to the following figures and appendix. The components in the figures and appendix are not necessarily to scale, emphasis instead being placed upon illustrating the principles of the disclosure.

In the figures, like reference numerals designate corresponding parts throughout the different views. All callouts in any appendices and/or figures are hereby incorporated by this reference.

FIG. 1A is an overview of a product flow showing unaccounted loss, in one embodiment;

FIG. 1B is an exemplary implementation of aspects of a method and system for dynamic and adaptive collection and use of data and metadata to improve efficiency and reduce leakage and theft during product flow;

FIG. 2 is an exemplary implementation of aspects of a method and system for dynamic and adaptive collection and use of data and metadata to improve efficiency and reduce leakage and theft;

FIG. 3 is an exemplary implementation of aspects of a method and system for dynamic and adaptive collection and use of data and metadata to improve efficiency and reduce leakage and theft;

FIG. 4 is an exemplary implementation of aspects of a method and system for dynamic and adaptive collection and use of data and metadata to improve efficiency and reduce leakage and theft;

FIG. 5 is an exemplary implementation of aspects of a work flow collecting data and metadata during manufacturing; and,

FIG. 6 is an exemplary implementation of aspects of a work flow collecting data and metadata via supply chain, product distribution and product returns.

All descriptions and callouts in the figures are hereby incorporated by this reference as if fully set forth herein.

### DETAILED DISCLOSURE

Persons of ordinary skill in the art of computer programming will recognize that the disclosure herein references operations that are performed by a computer system. Operations which are sometimes referred to as being computer-executed. Monitoring large production facilities and the volume of data and meta data points associated with the process, environment and workforce in a real-time or near real-time fashion benefits from computers to transform the collected data and assign relationships, values and form correlations based on criteria which also may be dynamic and varying. It will be appreciated that such operations are symbolically represented to include the manipulation by a processor, such as a cpu, with electrical signals representing data bits and the maintenance of data bits at memory locations, such as in system memory, as well as other processing of signals. Memory locations wherein data bits are maintained are physical locations that have particular electrical, magnetic, optical, or organic properties corresponding to the data bits.

When implemented in software, elements disclosed herein are aspects of some of the code segments to perform tasks. The code segments can be stored in a non-transitory processor readable medium, which may include any medium that can store information. Examples of the non-transitory processor readable mediums include an electronic circuit, a semiconductor memory device, a read-only memory (ROM), a flash memory or other non-volatile memory, an optical disk, a hard disk, etc. The term module may refer to a software-only implementation, a hardware-only implementation, or any combination thereof. Moreover, the term servers may both refer to the physical servers on which an application may be executed in whole or in part.

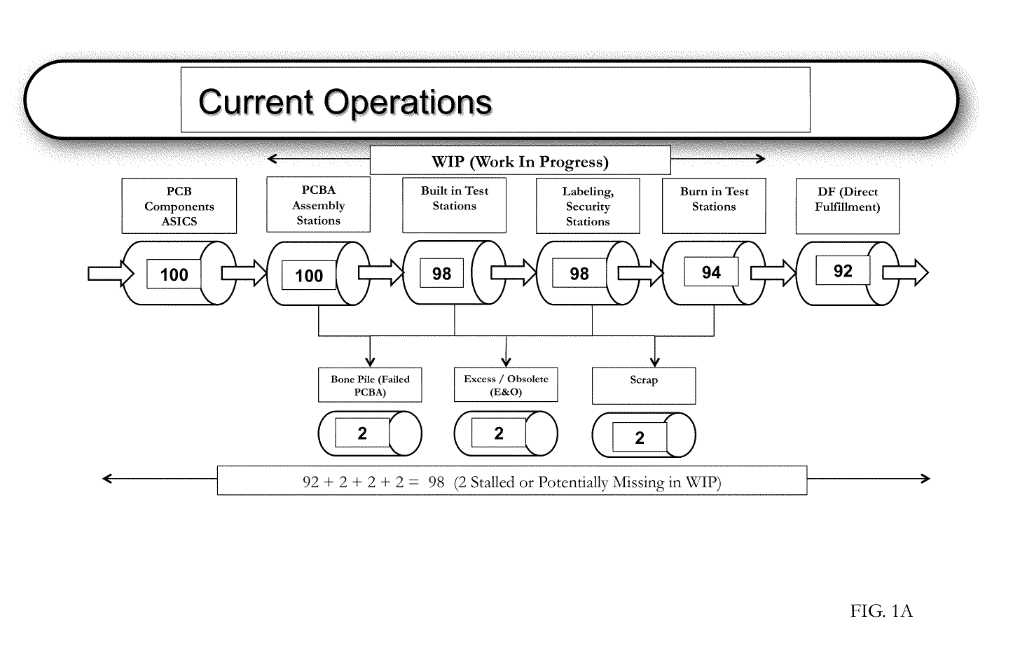

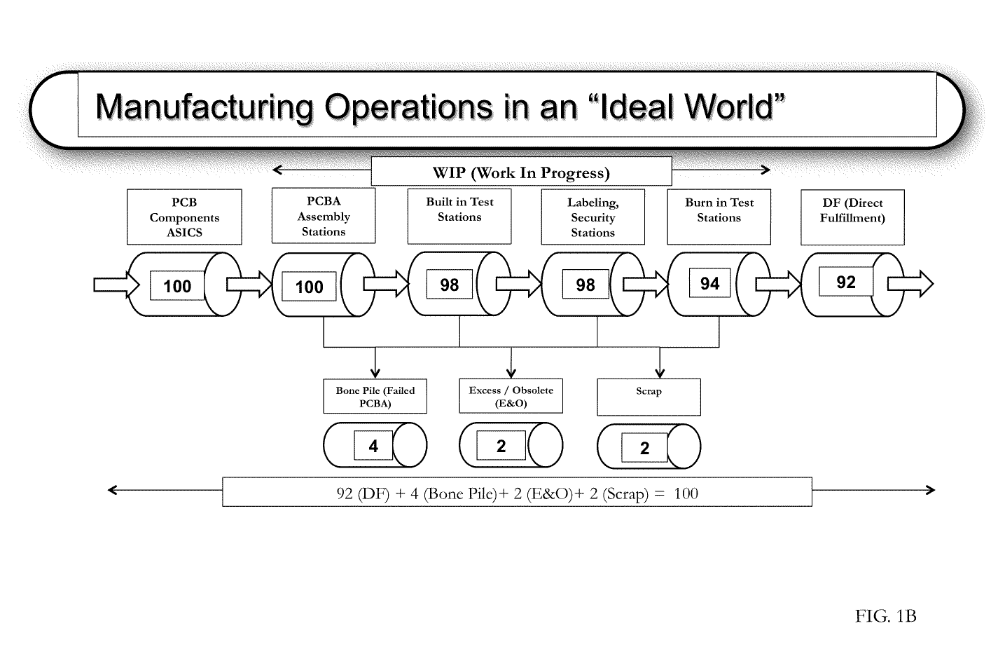

FIG. 1A show an overview of a product workflow in one embodiment. One hundred units of PCB (printed circuit board) ASICS component enter the food chain also referred to, in one embodiment, as the workflow. At the PCBA (PCB assembly) stations one hundred components enter but only ninety-eight units reach test stations and ninety-eight units are passed to labeling stations. However, only ninety-four units reach the burn in station and only ninety-two units arrive at direct fulfillment. During the above process steps the bone pile (which is a collection of failed units) shows an increase of two units, the excess/obsolete collection is increased by two units and the scrap pile is increased by two units, however the six units that are identified as removed from the food chain or the work flow do not reconcile with the eight missing units. The above work flow exemplifies product leakage in a traditional system. The leakage can be due to one or more of the PCB units being taken out of the food chain for legitimate reasons or a theft. In traditional systems no automated and computerized intelligence is available to monitor the process and help identify trends, alarms, data or meta-data that could track down the reason for the missing units.

A brand refers, in one embodiment, to a trademarked or otherwise identifiable designator that is a source of goods designator whether manufactured by or for the owner of the brand.

FIG. 1B show an overview of aspects of the method and system of a product workflow disclosed herein. One hundred units of PCB (printed circuit board) ASICS component enter the food chain also referred to as the workflow. Each PCB has a unique identifier device (UID) associated with it. UIDs may, in various embodiments, be a 1D or 2D barcode label, an RFID chip, Near Field Communication, and/or the like. For example the mechanical chassis may have one UID and Printed Circuit motherboard may have another UID and power supply serial another UID etc. At the PCBA (PCB assembly) stations one hundred components enter. In one embodiment, at entry, the UID(s) are acquired and a time stamp associated therewith. At this point the systems knows what exact unit is at which work station and at what time it arrived and at what time it moves to the next work station. Acquisition may, in various embodiments, be via scanning, robot vision, nearfield, wifi, optical, sensory, RF and/or the like. As is illustrated in FIG. 1A one hundred units enter the work flow and one-hundred units reach the PCBA assembly but only ninety-eight units reach test stations and ninety-eight units are passed to labeling stations. However, only ninety-four units reach the burn in station and only ninety-two units arrive at direct fulfillment.

During the above process steps, four components fail and are removed from the food chain and sent to the bone Pile (junked) where each UID associated with each unit is acquired and the entry to the bone Pile is time stamped. During the above process steps, two components are marked obsolete/excess and are removed from the food chain and each UID associated with each unit is acquired and the entry to the obsolete/excess pile is time stamped.

During the above process steps, two components are marked Scrap and are removed from the food chain and each UID associated with each unit is acquired and the entry to the scrap pile is time stamped.

Embodiments of the disclosed method provide real-time tracking and disposition information whereby the missing two units in the workflow of FIG. 1A are accounted for as being legitimately removed from the system. Had the monitoring shown that the units had stalled at one work station and then gone missing thereafter that data could, for example, set off alarms or warnings or be used to identify a loss, identify a trend, or predict future leakage.

The aforementioned is accomplished, in one embodiment, via at least one of automated real-time monitoring (track & traceability) of products in various stations within WIP automated end to end view and reconciliation of products manufactured within the facility; automated monitoring or tracking of products outside of active WIP i.e. Bone Pile, Scrap, Obsolete etc., automated checks and balances in place to track key IP components (ASICs, Smart Chips, etc.) for a brand owner including reconciliation against total products manufacture.

In various embodiments, the methods and systems described herein address the needs of, e.g.:

A. Component Suppliers:

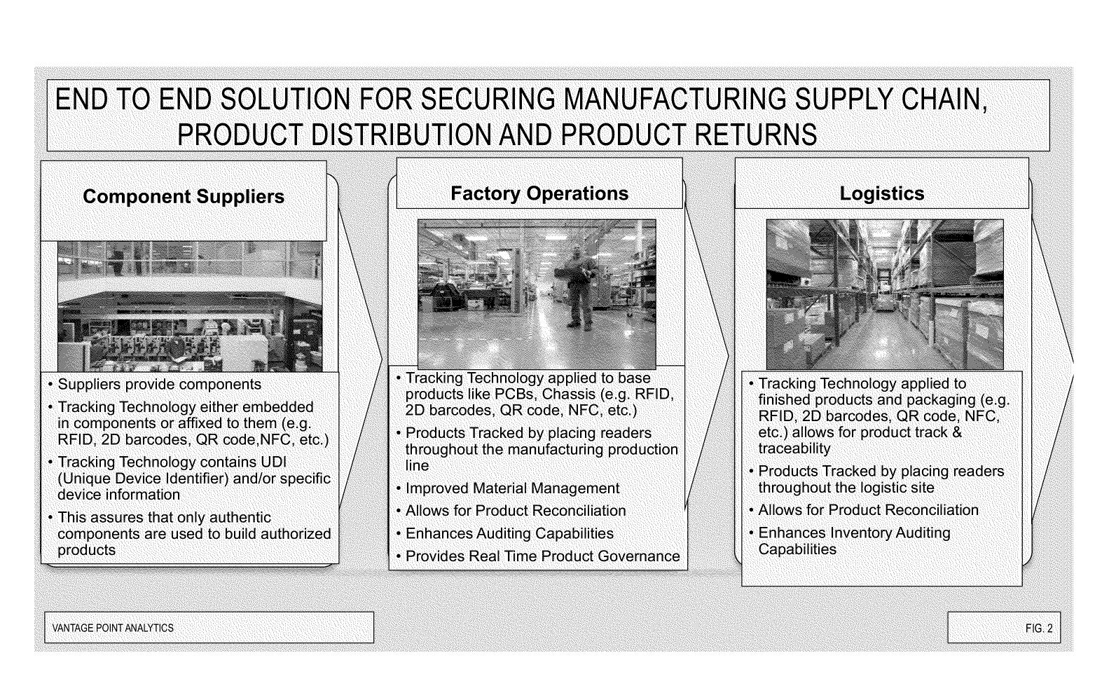

Suppliers provide components—tracking technology is, in some implementations, either embedded in components or affixed to them (e.g. RFID, 2D barcodes, QR code, NFC, etc.), said tracking technology contains UDI (Unique Device Identifier) and/or specific device information to gate keep that only authentic components are used to build authorized products. (FIG. 2).

B. Factory Operations:

Attached or applied UID (e.g. RFID, 2D barcodes, QR code, NFC, etc.) in products and components like PCBs, Chassis and other components (e.g., expensive or key ones) are, in one example, monitored with acquisition devices such as readers throughout the manufacturing production line. Such devices may, for example, provide data to a centralized system wherein one or more rule and decision engines are applied to improve material management, product reconciliation and/or enhance auditing capabilities. (FIG. 2).

C. Logistics:

Tracked UID associated with finished products and packaging allows for product track & traceability. Products may be tracked, for example, by placing readers throughout the logistic site, and improving product reconciliation and/or auditing. (FIG. 2).

D. Enforcement:

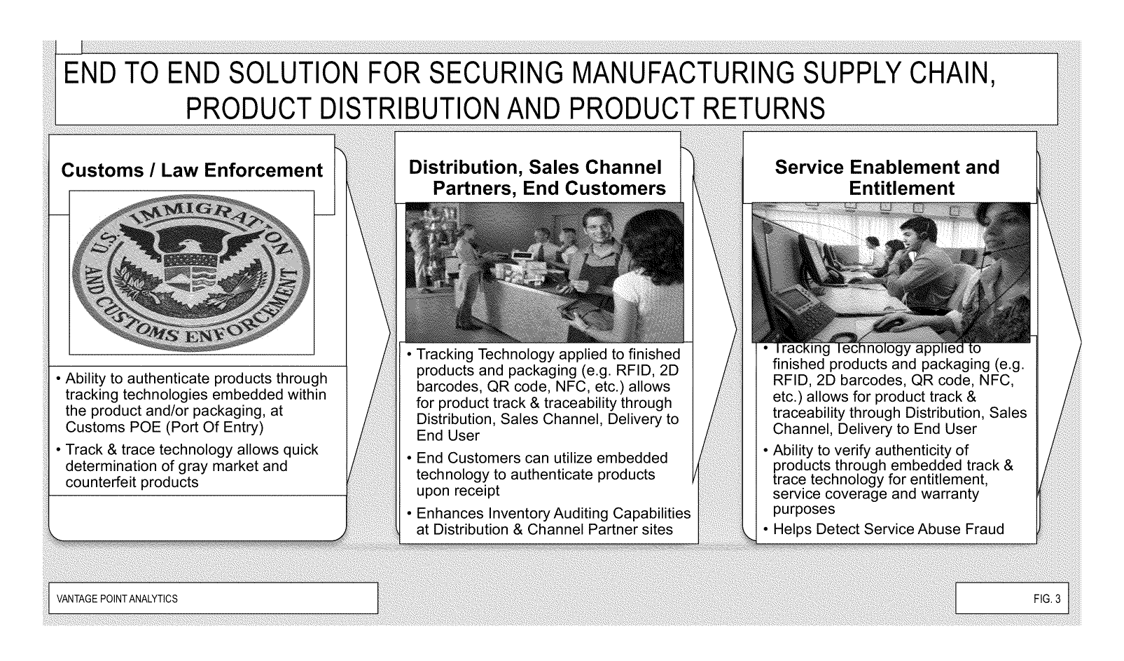

Embodiments of the disclosed methods and systems support an ability to authenticate products through tracking of one or more UIDs embedded within the product and/or packaging. In some implementations, tracking provides data and metadata such as geo-location, time, date, location of the product during specific time frames, route of transit and the like. The analysis of this associated data and metadata is valuable for Customs POE (Port Of Entry) to identify and reduce grey goods and counterfeit products. (FIG. 3).

E. Distribution, Sales Channel Partners, End Customers:

Embodiments of the disclosed methods and systems applied to finished products and packaging (e.g. RFID, 2D barcodes, QR code, NFC, etc.) allow for product track & traceability through distribution, sales channel, delivery, and/or the like to end user. In some implementations, end customers can also utilize embedded technology to authenticate products upon receipt. Aspects of the disclosed methods and systems also may enhance inventory auditing capabilities at distribution & channel partner sites. (FIG. 3).

E. Service Enablement and Entitlement:

Embodiments of the disclosed methods and systems applied to finished products and packaging (e.g. RFID, 2D barcodes, QR code, NFC, etc.) allow for product track & traceability through distribution, sales channel, delivery, and/or the like to end user. Aspects of the disclosed methods and systems provide the ability to verify authenticity of products for entitlement, service coverage and warranty purposes and can help flag or identify service abuse and fraud. (FIG. 3).

F. Product Returns & Reverse Logistics:

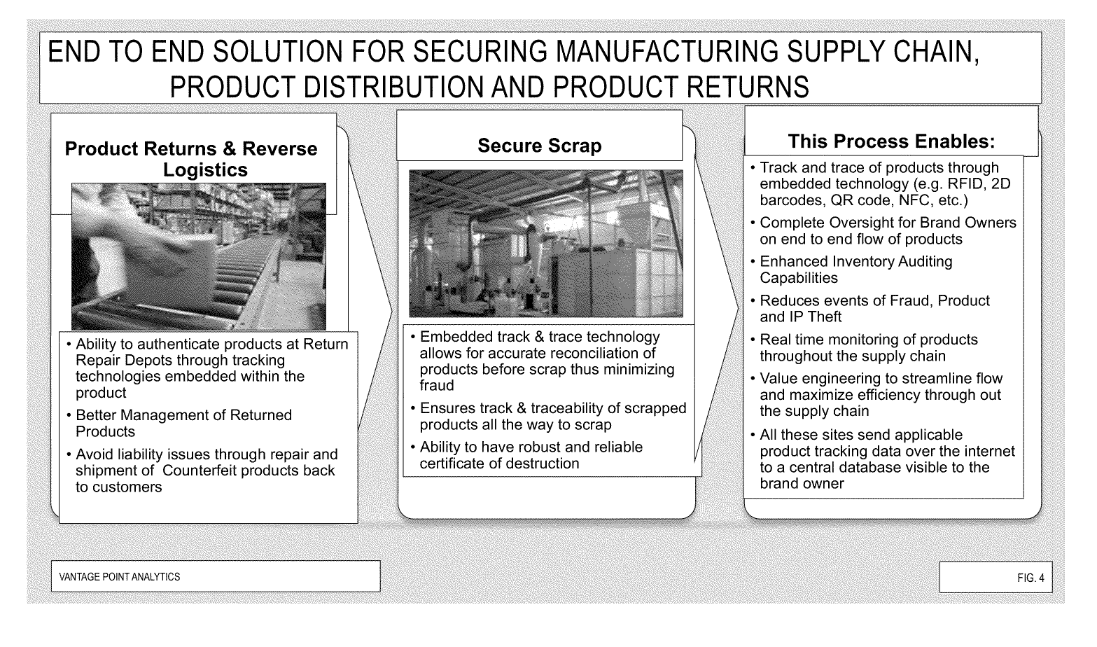

Embodiments of the disclosed methods and systems allow for authentication of products at return repair depots to manage the return process and avoid liability of allowing counterfeit products in the supply chain or to be returned. (FIG. 4).

G. Secure Scrap:

Embodiments of the disclosed methods and systems allow for accurate reconciliation of products before scrap thus minimizing fraud by ensuring track & traceability of scrapped products all the way to scrap including a robust and reliable certificate of destruction which may include one or more of history of product through work flow and food chain, date and time and place of various aspects of the manufacturing and supply chain and distribution of the product. (FIG. 4).

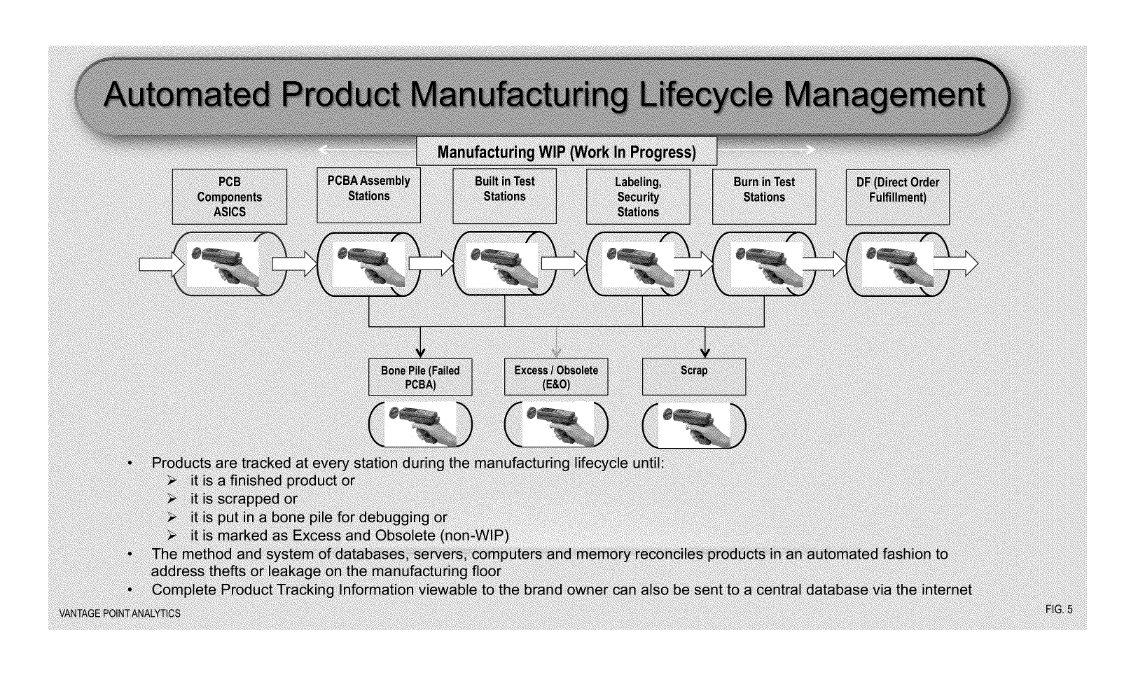

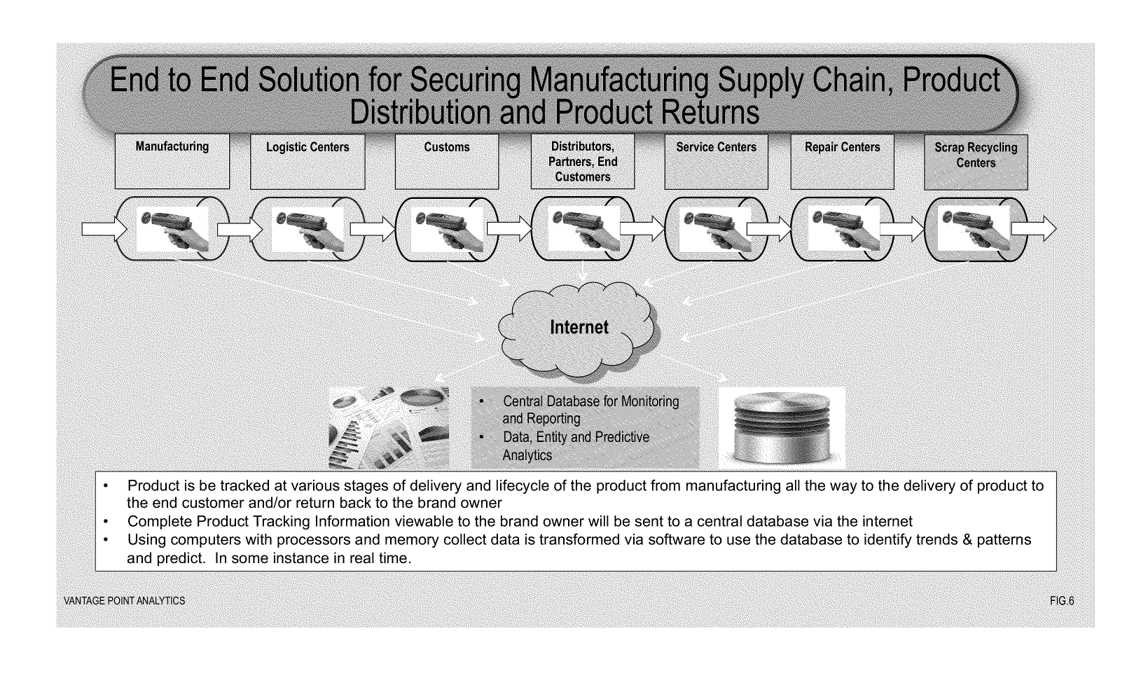

FIGS. 5 and 6 show overviews of the lifecycle management of a products and the manufacturing, supply and distribution in some embodiments. The illustrated hand scanner is not intended to be limiting, and a variety of other devices and systems to read a code, glyph, icon, RFID, transponder or other UID may be employed in alternative embodiments and implementations.

The systems and methods disclosed herein may also be understood be referring to the following, non-limiting, specific examples, which are provided only for illustrative purposes:

### Example 1

Overview: real-time monitoring of products (units) as they are being built and tested, move through multiple WIP assembly line stations on the manufacturing floor. These stations build, assemble and test a product before it is ready to be shipped to an end customer.

Step 1: Associate UDI (Unique Device Identifier) with product—A unique operator identifier (UOI) may also be associated with workers at WIP stations, which may include 1D or 2D barcode label, glyph, QR, RFID chip, Near Field Communication, or similar item . Multiple UDIs and UOIs may be associated with one final product. Multiples occur when key components are each associated with a UDI or multiple workers.

Step 2. At least one of UDI(s) and UOIs are acquired/read (or captured) upon entry and/or exit of the product or component from each of the WIP stations as mentioned above, including the timestamp of entry/exit.

Step 3. The data and metadata concerning at least one of the UOI and UDI is acquired, traditional data such as product ID may also be added to the database for analysis. That data being transmitted via a network to one or more databases which may include a centralized database at least one of onsite and offsite.

Step 4. Data analytics are applied to the data and metadata to determine if product is moving through WIP in within a threshold or nominal range. The analysis is dynamic and adaptive wherein the threshold is adjusted, sometimes in real-time, depending on a number of variables. monitoring the time spent in each station and comparing it to a set threshold. A dynamic and adaptive system (DAAS) collects data and metadata on movement of the product through WIP stations, during movement or workflow the DAAS determines if the movement is within the bell curve or “nominal” or if there are activities outside the threshold or bell curve. Being dynamic and adaptive it can adjust—for example a workflow value for a new operator UOI defines new operator, may be initially set at 15% lower than an experienced worker UOI defines experienced operator, or on a Friday after 12:00 pm historical data may show that workflow thresholds need to be adjusted downward 10%, or temperature monitoring of one or more areas of the production facility may show variations between WIP stations which are used to adjust thresholds for determining nominal values upward or downward.

Step 5. Alerts, warnings aka “Red flags” may be issued in real-time, as needed, or through automated reports generated as required which will capture a list of products and their last known location, the operator and if the operator or product has spent more than the threshold time defined for a certain station. One or more of the above sets of data are then correlated , analyzed and utilized to predict operator efficiency, WIP station efficiency, WIP station failures, trends, set alarms or set warning if activity is outside a threshold or limit. Eliciting an alarm in real-time is a means to reduce leakage. In leakage situations time is the enemy. If product is stalled at a WIP station the probability of loss increases.

### Example 2

Products physically located at Distributor & Partner sites will have an UDI (Unique Device Identifier) embedded in a RFID chip or similar technology.

Step 1. The UDI of a product will be acquired (captured) upon entry and exit of a product from the distributor or partner facility. This can be accomplished by placing readers at pre-determined locations. The time stamp on such entries and exit will also be captured. The method and system herein uses analyzes many data points including but not limited to Partner Name, Partner Location, Product ID, UDI, time stamp of entry/exit among other variables retrieved from the database;

Step 2. The data is captured via a computerized DAAS system and transmitted via a network to a centrally located database that will be accessible to the appropriate entities, computer systems and/or brand owner;

Step 3. The DAAS will also retrieve pertinent POS (Point of Sale) data points for the product in question from the brand owner's internal databases;

Step 4. The DAAS measures and correlates that particular manufactured products within a facilities of a Distributor or Partner are accounted for and in line with POS entries.

### Example 3

Products physically located at Distributor & Partner sites will have an UDI (Unique Device Identifier) embedded in a RFID chip or similar technology.

Step 1. The UDI of a product will be acquired (captured) upon entry and exit of a product from the distributor or partner facility. This can be accomplished by placing readers at pre-determined locations. The time stamp on such entries and exit will also be captured. The method and system herein uses analyzes many data points including but not limited to Partner Name, Partner Location, Product ID, UDI, time stamp of entry/exit among other variables retrieved from the database;

Step 2. The data is captured via a computerized DAAS system and transmitted via a network to a centrally located database that will be accessible to the appropriate entities, computer systems and/or brand owner;

Step 3. The DAAS will also retrieve pertinent POS (Point of Sale) data points for the product in question from the brand owner's internal databases;

Step 4. The DAAS measures and correlates that particular manufactured products within a facilities of a Distributor or Partner are accounted for and in line with POS entries.

Step 5: alarms or warnings may be issued, in some instances in real-time, or through automated reports generated on an as needed or set interval which will capture a list of products that show discrepancy capturing the nature of discrepancy i.e. if a product sitting on the floor of a Partner's facility in the U.S. should have been with a Partner or End Customer in China (gray market), thereby supporting real-time governance and reconciliation of products during Partner/Distributor audits

Those of ordinary skill in the art will recognize that a wide variety of look and feel variations may be provided via implementation of this disclosure and that the disclosure shows only limited examples of same which are not intended to limit the disclosure.

In the following description of examples of implementations, reference is made to the accompanying drawings that form a part hereof, and which show, by way of illustration, specific implementations of the present disclosure that may be utilized.

Other implementations may be utilized and structural changes may be made without departing from the scope of the present disclosure. All callouts in all figures are incorporated by this reference as if fully set forth herein. While the method and agent have been described in terms of what are presently considered to be the most practical implementations and aspects thereof, it is to be understood that the disclosure need not be limited to the disclosed implementations, aspects or order and/or sequence of combination of aspects. It is intended to cover various modifications and similar arrangements included within the spirit and scope of the claims, the scope of which should be accorded the broadest interpretation so as to encompass all such modifications and similar structures. The present disclosure includes any and all implementations of the following claims.

It should also be understood that a variety of changes may be made without departing from the essence of the disclosure. Such changes are also implicitly included in the description. They still fall within the scope of this disclosure. It should be understood that this disclosure is intended to yield a patent covering numerous aspects both independently and as an overall system and in both method and apparatus modes.

Further, each of the various elements of the disclosure and claims may also be achieved in a variety of manners. This disclosure should be understood to encompass each such variation, be it a variation of an implementation of any apparatus implementation, a method or process implementation, or even merely a variation of any element of these.

Particularly, it should be understood that as the disclosure relates to elements of the implementation, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this disclosure is entitled.

It should be understood that all actions may be expressed as a means for taking that action or as an element which causes that action. Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting, such statements are expressly not to be considered as made by the applicant(s). In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternatives.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps. Such terms should be interpreted in their most expansive forms so as to afford the applicant the broadest coverage legally permissible. All callouts associated with figures are hereby incorporated by this reference.

Since certain changes may be made in the above system, method, process and or apparatus without departing from the scope of the disclosure herein involved, it is intended that all matter contained in the above description, as shown in the accompanying drawing, shall be interpreted in an illustrative, and not a limiting sense.

While various embodiments of the disclosure have been described, it will be apparent to those of ordinary skill in the art that many more embodiments and implementations are possible within the scope of this disclosure. Moreover, it will be understood that the foregoing description of numerous implementations has been presented for purposes of illustration and description. It is not exhaustive and does not limit the claimed disclosures to the precise forms disclosed. Modifications and variations are possible in light of the above description or may be acquired from practicing the disclosure. The claims and their equivalents define the scope of the disclosure. Accordingly, the disclosure is not to be restricted except in light of the attached claims and their equivalents.

Such terms should be interpreted in their most expansive forms so as to afford the applicant the broadest coverage legally permissible.

1. A method to reduce product leakage, the method comprising:
associating a unique device identifier with a product which is scanned or otherwise read by a capture device upon one of entry and exit of the product from each Work In Progress “WIP” station including,
electronically adding at least one of a geo-location and timestamp; and,
transmitting the captured unique device identifier and the at least one of a geo-location and timestamp via a computer network to one or more databases for storage in memory.
